(19) United States
(12) Patent Application Publication
(10) Pub. No.: US 2019/0384021 A1
(43) Pub. Date: Dec. 19, 2019

(54) LIGHT RECEPTACLE, LIGHT MODULE, AND METHOD FOR PRODUCING LIGHT RECEPTACLE

(71) Applicant: Enplas Corporation, Saitama (JP)

(72) Inventor: Yasuhiro SUZUKI, Saitama (JP)

(21) Appl. No.: 16/467,073

(22) PCT Filed: Nov. 30, 2017
(86) PCT No.: PCT/JP2017/043033

§ 371 Date: Jun. 6, 2019

(30) Foreign Application Priority Data
Dec. 6, 2016 (JP) 2016-236650

(51) Int. Cl. G02B 6/42; G02B 6/32; G02B 6/38

(52) U.S. Cl. CPC G02B 6/4214; G02B 6/32; G02B 6/4284; G02B 6/424; G02B 6/3839; G02B 6/4292

(57) ABSTRACT

The purpose of the present invention is to provide a light receptacle which has a high degree of freedom in the arrangement position of a light receptacle main body, the wire bonding position, and the like. In order to achieve the above-described purpose, a light receptacle according to the present invention is arranged between a light transmission body and a photoelectric conversion device, and optically couples the photoelectric conversion element and the light transmission body to each other. The light receptacle comprises a light receptacle main body, a support member and an adhesive. The light receptacle main body comprises a first optical surface, a second optical surface, a reflective surface, a first fitting part and a groove part. The adhesive is arranged so as to be in contact with the inner wall surface of the groove part and the inner side of the support member main body.

### TECHNICAL FIELD

The present invention relates to an optical receptacle, an optical module including the optical receptacle, and a method for producing the optical receptacle.

### BACKGROUND ART

Conventionally, in optical communications using an optical transmission member such as an optical fiber, an optical waveguide, and/or the like, an optical module including a light-emitting element (optical element) such as a surface-emitting laser (e.g., a vertical cavity surface emitting laser (VCSEL)) has been used. Such an optical module includes an optical receptacle (optical socket) that allows, to be incident on an end surface of the optical transmission member such as an optical fiber, light containing communication information and being emitted by the light-emitting element.

For example, Patent Literature (hereinafter, referred to as “PTL”) 1 discloses an optical module including a substrate, an optical socket disposed on one surface of the substrate, and an optical element disposed on the other surface of the substrate at a position corresponding to the optical socket. An optical plug that supports an end of a tape fiber is attached to the optical socket. In addition, the optical socket includes: a first lens that allows, to enter the inside of the optical socket, light emitted by the optical element, or allows, to be emitted toward the optical element, light emitted from the tape fiber and having traveled through the inside of the optical socket; a second lens that allows, to enter the inside of the optical socket, light emitted from the tape fiber, or allows, to be emitted toward the tape fiber, light emitted by the optical element and having traveled through the inside of the optical socket; and a reflective surface that reflects light incident on the first lens toward the second lens, or reflects light incident on the second lens toward the first lens.

In the optical module disclosed in PTL 1, the optical element is fixed on one surface of the substrate by wire bonding or the like. Then, the optical socket is fixed on the other surface of the substrate such that the optical axis of the optical element coincides with the central axis of the first lens. At this time, the optical socket is adhered to the substrate by applying an adhesive agent to at least the optical socket or the substrate.

### CITATION LIST

### Patent Literature

### PTL 1

Japanese Patent Application Laid-Open No. 2004-246279

### SUMMARY OF INVENTION

### Technical Problem

However, there has been a problem in the optical module disclosed in PTL 1 in that a wire-bonding position of the optical element and/or a region in which other optical components, electronic components, and/or the like are disposed are limited since the optical socket is adhered directly to the substrate. Moreover, even when the optical socket and the substrate are disposed to be spaced apart from each other by fixing the optical socket using a cover or the like, the adhesive strength between the optical socket and the cover is supposed to be problematic because of a stress arising during attachment or detachment of the optical plug to or from the optical socket.

An object of the present invention is therefore to provide an optical receptacle which, compared to traditional optical sockets, can achieve a higher design flexibility for a disposition position of an optical-receptacle main body, a wire-bonding position of a photoelectric conversion element, a region in which other optical components and electronic components are disposed, and/or the like. The present invention also intends to provide an optical module including this optical receptacle. The present invention further intends to provide a method for producing the optical receptacle.

### Solution to Problem

An optical receptacle according to the present invention is an optical receptacle to be disposed between a photoelectric conversion device and an optical transmission member, the photoelectric conversion device including a substrate and a photoelectric conversion element disposed on the substrate, the optical receptacle being configured to optically couple together the photoelectric conversion element and an end surface of the optical transmission member, the optical receptacle including: an optical-receptacle main body; a supporting member that supports the optical-receptacle main body; and an adhesive agent that adheres the optical-receptacle main body and the supporting member to each other. The optical-receptacle main body includes: a first optical surface that allows incidence of transmission light emitted by the photoelectric conversion element, or emits, toward the photoelectric conversion element, reception light that has been emitted from the end surface of the optical transmission member and has passed through an inside of the optical-receptacle main body, a second optical surface that emits, toward the optical transmission member, the transmission light that has been emitted by the photoelectric conversion element and has passed through the inside of the optical-receptacle main body, or allows incidence of the reception light emitted from the optical transmission member, a reflective surface that reflects, toward the second optical surface, the transmission light incident on the first optical surface, or reflects, toward the first optical surface, the reception light incident on the second optical surface, a first fitting portion disposed in or on a surface of the optical-receptacle main body located opposite the first optical surface, and a groove disposed in the surface of the optical-receptacle main body located opposite the first optical surface to extend in a direction along an optical axis of the reception light that is incident on the second optical surface and travels toward the reflective surface or along an optical axis of the transmission light that is reflected on the reflective surface and travels toward the second optical surface, the groove not including an opening in a surface of the optical-receptacle main body on which the second optical surface is disposed. The supporting member includes: a supporting-member main body including an installation surface for the supporting member to be installed on the substrate, and a second fitting portion disposed on or in an inner side of the supporting-member main body at a position corresponding to the first fitting portion, the second fitting portion being fitted in or to the first fitting portion. The optical-receptacle main body is disposed on a side of the supporting member with respect to the installation surface. The adhesive agent is disposed to be in contact with an inner wall surface of the groove of the optical-receptacle main body and with the inner side of the supporting-member main body.

An optical module according to the present invention is a photoelectric conversion device including a substrate and a photoelectric conversion element disposed on the substrate; and the optical receptacle according to the present invention, in which the substrate and the optical-receptacle main body are spaced apart from each other.

A method for producing the optical receptacle according to the present invention includes: applying an adhesive agent to the groove of the optical-receptacle main body; fitting the first fitting portion of the optical-receptacle main body to which the adhesive agent is applied, and the second fitting portion of the supporting member to each other; and curing the adhesive agent.

### Advantageous Effects of Invention

According to the present invention, it is possible to provide an optical receptacle which, compared to traditional optical sockets, can achieve a higher design flexibility for a disposition position of an optical-receptacle main body, a wire-bonding position of a photoelectric conversion element, disposition positions of other optical components and electronic components, and/or the like.

### BRIEF DESCRIPTION OF DRAWINGS

FIG. 1 is a schematic sectional view of an optical module according to an embodiment of the present invention;

FIG. 2A is a perspective view of an optical-receptacle main body according to an embodiment of the present invention, FIG. 2B is a plan view of the optical-receptacle main body, FIG. 2C is a rear view of the optical-receptacle main body, FIG. 2D is a front view of the optical-receptacle main body, FIG. 2E is a bottom view of the optical-receptacle main body, and FIG. 2F is a side view of the optical-receptacle main body.

FIG. 3A is a sectional view taken along line A-A in FIG. 2B, and FIG. 3B is a partly enlarged view of region B circled with the dashed line illustrated in FIG. 2C;

FIG. 4A is a perspective view of supporting member 150 according to an embodiment of the present invention, FIG. 4B is a plan view of supporting member 150, FIG. 4C is a front view of supporting member 150, FIG. 4D is a rear view of supporting member 150, FIG. 4E is a side view of supporting member 150, FIG. 4F is a bottom view of supporting member 150, and FIG. 4G is a sectional view of supporting member 150 taken along line A-A in FIG. 4F;

FIG. 5A is a plan view of an optical-receptacle main body according to a modification of the present invention, FIG. 5B is a rear view of the optical-receptacle main body, and FIG. 5C is a partly enlarged view of region A circled with the dashed line illustrated in FIG. 5B;

FIG. 6A is a plan view of an optical-receptacle main body according to a modification of the present invention, FIG. 6B is a rear view of the optical-receptacle main body, and FIG. 6C is a partly enlarged view of region A circled with the dashed line illustrated in FIG. 6B;

FIG. 7A is a plan view of an optical-receptacle main body according to a modification of the present invention, FIG. 7B is a rear view of the optical-receptacle main body, and FIG. 7C is a partly enlarged view of region A circled with the dashed line illustrated in FIG. 7B;

FIG. 8A is a plan view of an optical-receptacle main body according to a modification of the present invention, FIG. 8B is a rear view of the optical-receptacle main body, and FIG. 8C is a partly enlarged view of region A circled with the dashed line illustrated in FIG. 8B;

FIG. 9A is a perspective view of an optical-receptacle main body according to a modification of the present invention, FIG. 9B is a plan view of the optical-receptacle main body, and FIG. 9C is a rear view of the optical-receptacle main body; and

FIG. 10A is a perspective view of an optical-receptacle main body according to a modification of the present invention, FIG. 10B is a plan view of the optical-receptacle main body, and FIG. 10C is a rear view of the optical-receptacle main body.

### DESCRIPTION OF EMBODIMENTS

Hereinafter, an optical module according to one embodiment of the present invention will be described with reference to the attached drawings.

(Configuration of Optical Module)

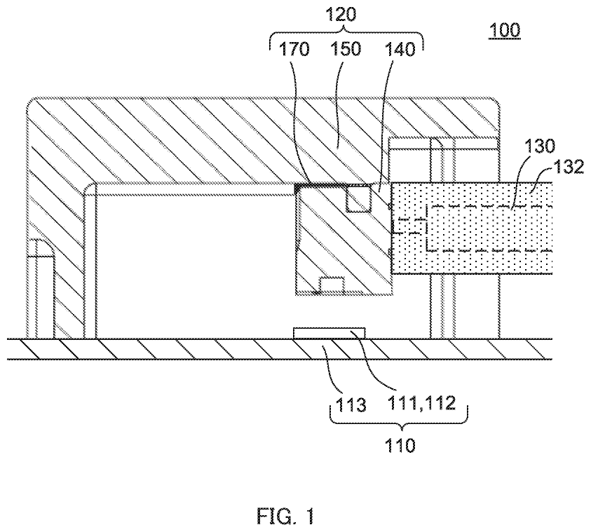

As illustrated in FIG. 1, optical module 100 of the present invention includes substrate-mounted photoelectric conversion device 110, such as light-emitting element 111, light-receiving element 112, and/or the like, and optical receptacle 120. Optical module 100 is used in a state where optical transmission members 130 are connected to optical receptacle 120 via ferrule 132.

Photoelectric conversion device 110 includes substrate 113 and a photoelectric conversion element. In optical module 100 for transmission, light-emitting element 111 is used as the photoelectric conversion element. Additionally, in optical module 100 for reception, light-receiving element 112 is used as the photoelectric conversion element. Further, in optical module 100 for transmission and reception, light-emitting element 111 and light-receiving element 112 are used as the photoelectric conversion elements. The present embodiment will be described in relation to optical module 100 for transmission and reception including light-emitting element 111 and light-receiving element 112.

Substrate 113 is, for example, a glass composite substrate, glass epoxy substrate, flexible printed circuit board, or the like. Light-emitting element 111 and light-receiving element 112 are disposed on substrate 113. Additionally, an alignment mark is formed as needed on the surface of substrate 113 on which light-emitting element 111 and light-receiving element 112 are disposed.

Light-emitting element 111 is disposed on substrate 113, and emits laser light in a direction perpendicular to the surface of substrate 113 on which light-emitting element 111 is disposed. The number of light-emitting elements 111 is not limited specifically. Four light-emitting elements 111 are provided in the present embodiment. The positions of light-emitting elements 111 are also not limited specifically. Four light-emitting elements 111 are arranged at regular intervals along an arrangement direction in which optical transmission members 130 are arranged. Light-emitting elements 111 are a vertical cavity surface emitting laser (VCSEL), for example. Note that, when optical transmission members 130 are arranged in two or more rows, the number of rows of arranged light-emitting elements 111 may be identical to that of optical transmission members 130.

Light-receiving element 112 is disposed on substrate 113, and receives reception light emitted from optical transmission members 130. The number of light-receiving elements 112 is not limited specifically. Four light-receiving elements 112 are provided in the present embodiment. The positions of light-receiving elements 112 are also not limited specifically. Four light-receiving elements 112 are arranged at regular intervals in one row along an arrangement direction in which optical transmission members 130 are arranged. Specifically, four light-receiving elements 112 are arranged such that four light-emitting elements 111 and four light-receiving elements 112 are situated on the same straight line. Light-receiving elements 112 are, for example, a photodiode (PD). Note that, when optical transmission members 130 are arranged in two or more rows, the number of rows of arranged light-receiving elements 112 may be identical to that of optical transmission members 130.

The alignment mark (not illustrated) is used for the purpose of alignment during production of optical module 100, and serves as a basis for positioning optical receptacle 120 with respect to substrate 113. The alignment mark may be a recess formed in substrate 113, a protrusion formed on substrate 113, or a mark provided by painting. In addition, the shape of the alignment mark as seen in plan view is not limited specifically, and may be circular or polygonal. The position of the alignment mark is also not limited.

The type of optical transmission members 130 is not limited specifically, and examples of optical transmission members 130 include an optical fiber, optical waveguide, and the like. Optical transmission members 130 are an optical fiber in the present embodiment. The optical fiber may be of a single mode type, or a multiple mode type. The number of optical transmission members 130 is not limited specifically. Eight optical fibers are arranged in a row in the present embodiment. Note that, optical transmission members 130 may also be arranged in two or more rows.

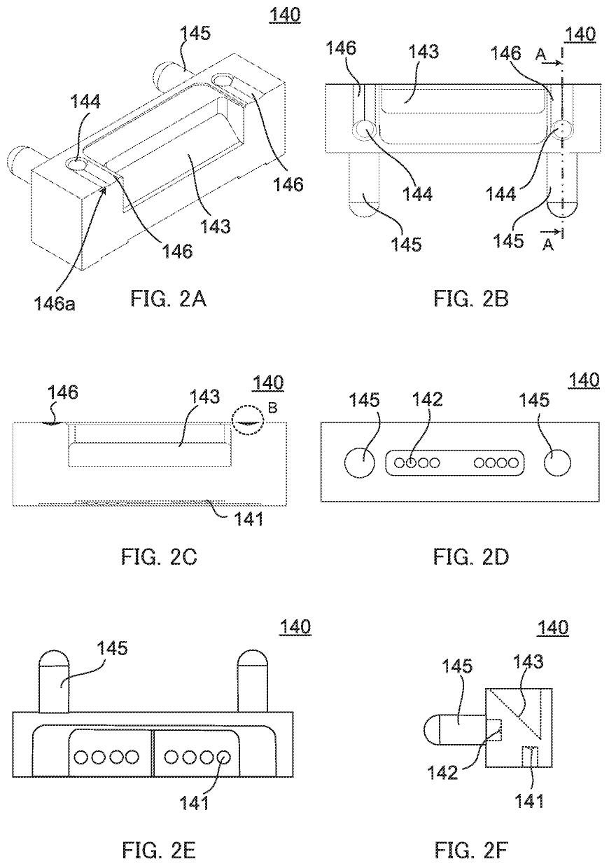

Ferrule 132 holds ends of optical transmission members 130, and also positions the end surfaces of optical transmission members 130 with respect to second optical surfaces 142 of optical-receptacle main body 140 (see FIGS. 2A to 2F). Ferrule 132 is configured to hold the ends of optical transmission members 130, and to be freely attached or detached to or from optical-receptacle main body 140 of optical receptacle 120.

Disposed between photoelectric conversion device 110 and optical transmission members 130, optical receptacle 120 optically couples the light-emitting surfaces of a plurality of light-emitting elements 111 to the end surfaces of a plurality of optical transmission members 130, respectively. Optical receptacle 120 also optically couples the light-receiving surfaces of a plurality of light-receiving elements 112 to the end surfaces of a plurality of optical transmission members 130, respectively.

(Configuration of Optical Receptacle)

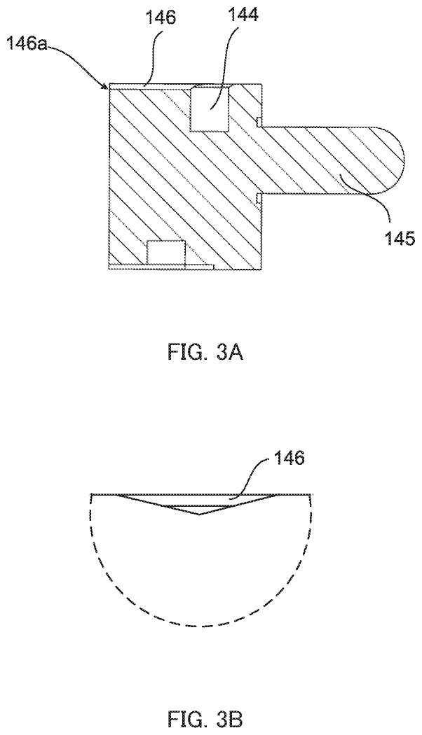

As illustrated in FIG. 1, optical receptacle 120 includes optical-receptacle main body 140, supporting member 150 that supports optical-receptacle main body 140, and adhesive agent 170 that adheres optical-receptacle main body 140 and supporting member 150 to each other. The “adhesive agent” as used herein means both a fluid adhesive agent before being cured and a cured object after being cured. Hereinbelow, the configuration of optical receptacle 120 is described in detail. FIGS. 2A to 2F illustrate the configuration of optical-receptacle main body 140. FIG. 2A is a perspective view of optical-receptacle main body 140, FIG. 2B is a plan view of optical-receptacle main body 140, FIG. 2C is a rear view of optical-receptacle main body 140, FIG. 2D is a front view of optical-receptacle main body 140, FIG. 2E is a bottom view of optical-receptacle main body 140, and FIG. 2F is a side view of optical-receptacle main body 140. Additionally, FIG. 3A is a sectional view of optical-receptacle main body 140 taken along line A-A in FIG. 2B, and FIG. 3B is a partly enlarged view of region B circled with the dashed line illustrated in FIG. 2C.

Optical-receptacle main body 140 is an optically transparent member having a substantially rectangular parallelepiped shape, and includes a plurality of first optical surfaces 141, a plurality of second optical surfaces 142, reflective surface 143, first fitting portions 144, ferrule protrusions 145, and grooves 146 as illustrated in FIGS. 2A to 2E Optical-receptacle main body 140 is formed using a material optically transparent to the light of wavelengths used for optical communications. Examples of such a material include transparent resins, such as polyetherimide (PEI), cyclic olefin resin, and the like.

First optical surfaces 141 are optical surfaces which are disposed on the bottom surface of optical-receptacle main body 140 and which are for allowing, to enter the inside of optical-receptacle main body 140, the transmission light emitted by light-emitting elements 111, while refracting the transmission light. First optical surfaces 141 are also optical surfaces for emitting, toward light-receiving elements 112, the reception light having traveled from optical transmission members 130 through the inside of optical receptacle 120, while refracting the reception light. As for the shape of first optical surfaces 141, first optical surfaces 141 are convex lens surfaces that are convex toward light-emitting elements 111 (or light-receiving elements 112) in the present embodiment. Additionally, each of first optical surfaces 141 is circular in plan view. First optical surfaces 141 convert, into collimated light, the transmission light emitted by light-emitting elements 111. In addition, first optical surfaces 141 converge collimated light (reception light) having traveled through the inside of optical receptacle 120. In the present embodiment, a plurality of (eight) first optical surfaces 141 are disposed in a single row to face the light-emitting surfaces of light-emitting elements 111 and the light receiving surfaces of light-receiving elements 112, respectively. Note that, when light-emitting elements 111 and light-receiving elements 112 are arranged in two or more rows, the number of rows of arranged first optical surfaces 141 is identical to that of light-emitting elements 111 and light-receiving elements 112. It is preferable that the central axes of first optical surfaces 141 be orthogonal to the light-emitting surfaces of light-emitting elements 111 and the light-receiving surfaces of light-receiving elements 112. It is also preferable that the central axes of first optical surfaces 141 coincide with the optical axes of the light rays emitted by light-emitting elements 111 (or with rays of the reception light to be incident on light-receiving elements 112).

Here, the light incident on first optical surfaces 141 travels toward reflective surface 143. The reception light emitted from first optical surfaces 141 travels toward light-receiving elements 112. Four of eight first optical surfaces 141 on the right side in the illustration of FIG. 2E are used as transmission-side first optical surfaces 141, and the other four first optical surfaces 141 on the left side are used as reception-side first optical surfaces 141 in the present embodiment. That is, the transmission light from light-emitting elements 111 is incident on four transmission-side first optical surfaces 141 on the right side in the illustration, and the reception light having traveled through the inside of optical-receptacle main body 140 is emitted from four reception-side first optical surfaces 141 on the left side in the illustration. Eight first optical surfaces 141 are thus divided equally such that a half of them functions as the transmission-side optical surfaces and the other half functions as the reception-side optical surfaces in optical-receptacle main body 140 according to the present embodiment.

Second optical surfaces 142 are optical surfaces which are disposed on the front surface of optical-receptacle main body 140 and which are for emitting, toward the end surfaces of optical transmission members 130, the transmission light incident on first optical surfaces 141 and reflected on reflective surface 143. Second optical surfaces 142 are also optical surfaces for allowing, to enter the inside of optical receptacle 120, the reception light emitted from the end surfaces of optical transmission members 130, while refracting the reception light. As for the shape of second optical surfaces 142, second optical surfaces 142 are convex lens surfaces that are convex toward the end surfaces of optical transmission members 130 in the present embodiment. Additionally, each of second optical surfaces 142 is circular in plan view. Second optical surfaces 142 converge, toward the end surfaces of optical transmission members 130, the transmission light having traveled through the inside of optical-receptacle main body 140, and also convert the reception light emitted from optical transmission members 130 into collimated light. In addition, a plurality of (eight) second optical surfaces 142 are arranged in a single row as illustrated in FIG. 2D in the present embodiment so as to face the end surfaces of optical transmission members 130, respectively. Note that, when optical transmission members 130 are arranged in two or more rows, the number of rows of arranged second optical surfaces 142 is identical to that of optical transmission members 130. It is preferable that the central axes of second optical surfaces 142 be orthogonal to the end surfaces of optical transmission members 130. It is also preferable that the central axes of second optical surfaces 142 coincide with the optical axes of the light rays emitted from optical transmission members 130.

The light incident on second optical surfaces 142 travels toward reflective surface 143. The transmission light emitted from second optical surfaces 142 travels toward optical transmission members 130. Four of eight second optical surfaces 142 on the right side in the illustration of FIG. 2D are used as transmission-side second optical surfaces 142, and the other four second optical surfaces 142 on the left side are used as reception-side second optical surfaces 142 in the present embodiment. That is, the transmission light having passed through the inside of optical receptacle 120 is emitted from four transmitting-side second optical surfaces 142 on the right side in the illustration, and the reception light emitted from optical transmission members 130 is incident on four reception-side second optical surfaces 142 on the left side in the illustration. Eight second optical surfaces 142 are divided equally such that a half of them functions as the transmission-side optical surfaces and the other half functions as the reception-side optical surfaces in optical-receptacle main body 140 according to the present embodiment.

Reflective surface 143 is a surface that is disposed on the side of the top panel of optical-receptacle main body 140 and that reflects the transmission light incident on first optical surfaces 141 toward second optical surfaces 142. Reflective surface 143 also reflects the reception light incident on second optical surfaces 142 toward first optical surfaces 141. In the present invention, reflective surface 143 is inclined such that the distance from reflective surface 143 to second optical surfaces 142 (or to optical transmission members 130) increases with increasing distance from the top panel to the bottom surface of optical receptacle 120 as illustrated in FIG. 2F. The inclination angle of reflective surface 143 is 45 degrees with respect to the optical axis of light incident on first optical surfaces 141 and with respect to the optical axis of light incident on second optical surfaces 142.

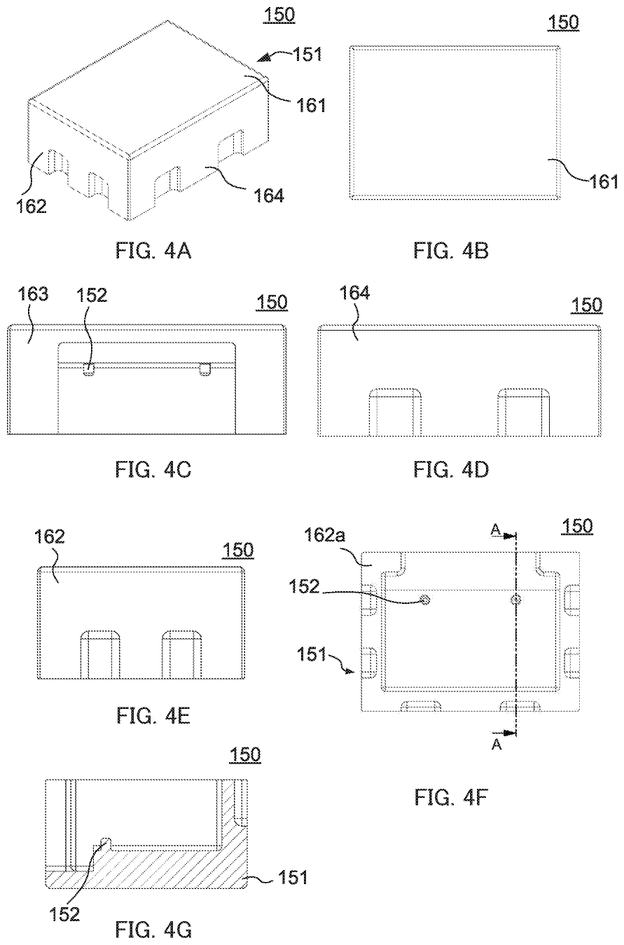

First fitting portions 144 are regions disposed in the top panel of optical-receptacle main body 140 in which second fitting portions 152 (see FIGS. 4A to 4G) of supporting member 150 are fitted. Optical-receptacle main body 140 and supporting member 150 are positioned by fitting first fitting portions 144 and second fitting portions 152 to each other, and this fitting also makes positional shifts of them less likely to occur even during attachment or detachment of ferrule 132. The shape and number of first fitting portions 144 are not limited specifically as long as first fitting portions 144 can fulfil the above-mentioned function. First fitting portions 144 are cylindrical recesses that are open in the top panel of optical-receptacle main body 140, and are disposed at the opposite sides of reflective surface 143.

Ferrule protrusions 145 are protrusions disposed on the front surface of optical-receptacle main body 140 for being fitted into recesses formed in ferrule 132. Ferrule protrusions 145 and the recesses formed in ferrule 132 are fitted to each other, so that the positions of the end surfaces of optical transmission members 130 are determined with respect to optical-receptacle main body 140. The shape and number of ferrule protrusions 145 are not limited specifically. Two ferrule protrusions 145 are disposed respectively at the opposite sides of a row of second optical surfaces 142 in the present embodiment.

Grooves 146 are grooves disposed in the top panel of optical-receptacle main body 140 for an adhesive agent to be disposed therein. Grooves 146 are disposed to extend along the optical axis of the reception light that is incident on second optical surfaces 142 and travels toward the side of reflective surface 143 and along the optical axis of the transmission light that is reflected on reflective surface 143 and travels toward second optical surfaces 142 (that is, along a direction in which the front surface and rear surface of optical-receptacle main body 140 are connected). The shape of grooves 146 as seen in plan view and the number of grooves 146 are not limited specifically as long as grooves 146 do not affect the optical characteristics of optical-receptacle main body 140. In the present embodiment, two grooves 146 each of which is linear in plan view are disposed respectively at the opposite sides of reflective surface 143 as illustrated in FIG. 2A. In addition, the width of each of grooves 146 is appropriately selected according to desired adhesive strength (adhesive strength between optical-receptacle main body 140 and supporting member 150).

The sectional shape of each of grooves 146 is also not limited specifically, and can, e.g., be V-shaped or trapezoidal. The sectional shape is V-shaped in the present embodiment. The depth is also not limited specifically. Note that, the “sectional shape of each of grooves 146” as used herein means the shape of each of grooves 146 in section taken along a direction parallel to the front surface of optical-receptacle main body 140.

Here, each of grooves 146 does not have an opening in the side of the second optical surfaces. That is, the end of each of grooves 146 on the side of the second optical surfaces is disposed within the top panel of optical-receptacle main body 140. It is thus possible to prevent the adhesive agent from entering on the side of the second optical surfaces during production of optical receptacle 120, so as to reduce deterioration in optical characteristics of optical receptacle 120 due to the adhesive agent. Meanwhile, grooves 146 respectively include openings 146a in the side of the rear surface of optical-receptacle main body 140 in the present embodiment. Openings 146a of grooves 146 are disposed in the side of the rear surface of optical-receptacle main body 140, so that an excessive adhesive agent can be discharged from openings 146a toward the side of the rear surface of optical-receptacle main body 140 during production of optical receptacle 120. Consequently, optical-receptacle main body 140 and supporting-member main body 150 can be joined tightly to each other, and can be adhered firmly to each other.

Note that, although first fitting portions 144 are disposed near the ends of grooves 146 on the side of second optical surfaces 142 in the present embodiment, the relationship between the position of first fitting portions 144 and the position of grooves 146 is not limited specifically, and first fitting portions 144 and grooves 146 may be disposed at distant positions.

Note also that, although not illustrated in particular, an alignment mark may be disposed on optical-receptacle main body 140. The alignment mark may be used for alignment during production of optical module 100 described above.

FIGS. 4A to 4G illustrate a configuration of supporting member 150. FIG. 4A is a perspective view of supporting member 150, FIG. 4B is a plan view of supporting member 150, FIG. 4C is a front view of supporting member 150, FIG. 4D is a rear view of supporting member 150, FIG. 4E is a side view of supporting member 150, FIG. 4F is a bottom view of supporting member 150, and FIG. 4G is a sectional view of supporting member 150 taken along line A-A in FIG. 4F.

Supporting member 150 supports optical-receptacle main body 140 such that substrate 113 and optical-receptacle main body 140 are spaced apart from each other. As illustrated in FIGS. 4A to 4G, supporting member 150 includes supporting-member main body 151 and second fitting portions 152 disposed on the inner side of supporting-member main body 151. Supporting member 150 may be formed of an optically-transparent or optically-untransparent material. Supporting member 150 is formed of an optically transparent resin, such as polycarbonate (PC), polyether imide (PEI), polyether sulfone (PES), or the like in the present embodiment.

The shape of supporting-member main body 151 is not limited specifically as long as supporting-member main body 151 can fulfil the above-mentioned function. Supporting-member main body 151 includes top plate 161, a pair of side plates 162, front plate 163 that connects top plate 161 and the pair of side plates 162, and rear plate 164 that connects top plate 161 and the pair of side plates 162 in the present embodiment. Note that, the lower surfaces of side plates 162, front plate 163, and rear plate 164 function as installation surface 162a for installation of optical receptacle 120 on substrate 113.

Here, second fitting portions 152 are disposed on the inner side of top plate 161 at positions corresponding to first fitting portions 144 of optical-receptacle main body 140. Second fitting portions 152 may have any shape as long as second fitting portions 152 are substantially complementary to first fitting portions 144 of optical-receptacle main body 140. Second fitting portions 152 are substantially cylindrical in the present embodiment. In addition, the number of second fitting portions 152 is identical to the number of first fitting portions 144. That is, two second fitting portions 152 are provided.

Here, the pair of side plates 162 is disposed such that the height of side plates 162 is greater than the height of optical-receptacle main body 140. With this configuration, optical-receptacle main body 140 is disposed on the side of supporting-member 150 with respect to installation surface 162a. That is, when supporting-member main body 151 supports optical-receptacle main body 140, a space is formed between optical-receptacle main body 140 and substrate 113.

Note that, an alignment mark may be disposed on the outside of top plate 161 of supporting-member main body 151 as necessary. The alignment mark is used for alignment during production of optical module 100. More specifically, the alignment mark serves as a basis for positioning optical receptacle 120 with respect to substrate 113. The configuration of the alignment mark is not limited specifically as long as the alignment mark can fulfil the above-mentioned function. The alignment mark may be a recess formed in top plate 161, a protrusion formed on top plate 161, or a mark provided by painting. The shape of the alignment mark as seen in plan view is also not limited specifically, and may be circular or polygonal.

Adhesive agent 170 is disposed between grooves 146 of optical-receptacle main body 140 and top plate 161 of supporting-member main body 151. More specifically, adhesive agent 170 is disposed to come into contact with the inner wall surfaces of grooves 146, and with the inner side of top plate 161 of supporting-member main body 151. Adhesive agent 170 is disposed between optical-receptacle main body 140 and supporting member 150, so that optical-receptacle main body 140 and supporting member 150 are adhered firmly to each other, and optical-receptacle main body 140 is supported by supporting member 150.

Note that, adhesive agent 170 may further be disposed not only between grooves 146 and top plate 161 of supporting-member main body 151 but also on the rear surface of optical-receptacle main body 140 and on the surface of top plate of supporting member 161. Adhesive agent 170 extruded from grooves 146 during production of optical receptacle 120 and disposed on (adhered to) top plate 161 of supporting-member main body 151 and/or the like improves the adhesive strength between optical-receptacle main body 140 and supporting member 150. Accordingly, optical-receptacle main body 140 and supporting member 150 become even less likely to be separated from each other even when a load is applied to optical-receptacle main body 140 during attachment or detachment of ferrule 132. Note that, adhesive agent 170 can, for example, be an epoxy-based adhesive agent or the like.

(Method for Producing Optical Receptacle)

Optical receptacle 120 according to the embodiment described above can be produced using the following method, for example. To begin with, optical-receptacle main body 140 and supporting member 150 are manufactured by injection molding or the like. Subsequently, optical receptacle 120 described above can be obtained by performing a step of applying adhesive agent 170 to grooves 146 of optical-receptacle main body 140 (adhesive agent application step), a step of fitting first fitting portions 144 of optical-receptacle main body 140 and second fitting portions 152 of supporting member 150 to each other (fitting step), a step of curing adhesive agent 170 in a state where first fitting portions 151 and second fitting portions 152 are fitted to each other (adhesive agent curing step).

The method of applying adhesive agent 170 to grooves 146 of optical-receptacle main body 140 is not limited specifically in the adhesive agent application step, and adhesive agent 170 can, e.g., be applied with a dispenser or the like. At this time, it is preferable to apply adhesive agent 170 such that adhesive agent 170 does not enter first fitting portions 144. In addition, the amount of adhesive agent 170 to be applied is not limited specifically as long as the amount of adhesive agent 170 is as much as adhesive agent 170 can come into contact with the inner walls of grooves 146 and with the inner side of the top plate of supporting-member main body 151 after adhesive agent 170 is cured. The amount of adhesive agent 170 is appropriately selected depending on the depths and/or widths of grooves 146. In addition, the kind of adhesive agent 170 to be applied is appropriately selected depending on the materials of optical-receptacle main body 140 and/or supporting-member main body 151, and can, e.g., be epoxy-based adhesive agent 170. Note that, even when the amount of adhesive agent 170 applied in the adhesive agent application step is larger than the volume of grooves 146, excessive part of adhesive agent 170 can be discharged from openings 146a of grooves 146 to the outside of grooves 146 in the present embodiment.

Additionally, the method of fitting first fitting portions 144 of optical-receptacle main body 140 and second fitting portions 152 of supporting member 150 to each other in the fitting step is not limited specifically, and can be a well-known method.

Additionally, examples of the method of curing adhesive agent 170 in the adhesive agent curing step include heating. The heating temperature at this time is appropriately selected depending on the heat-resistance temperatures of supporting-member main body 151 and/or of optical receptacle 140, the kind of adhesive agent 170, and/or the like.

(Modification)

Although first fitting portions 144 disposed in optical-receptacle main body 140 are recesses and second fitting portions 152 disposed on supporting member 150 are protrusions in the embodiment described above, first fitting portions 144 may also be protrusions and second fitting portions 152 may also be recesses.

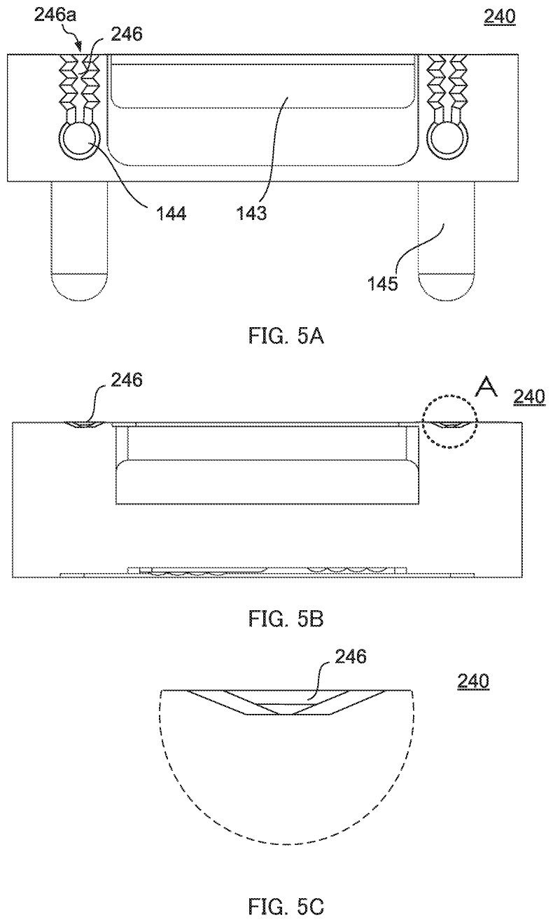

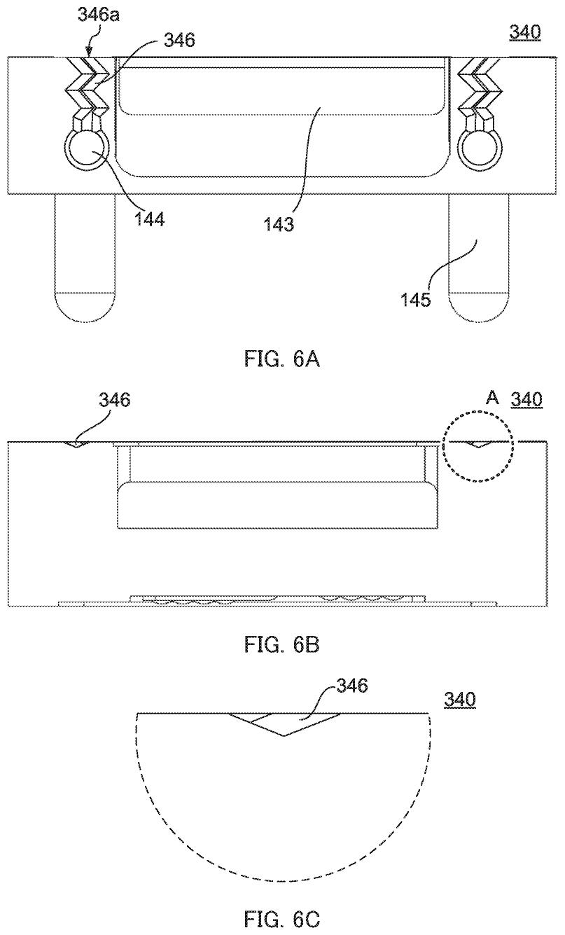

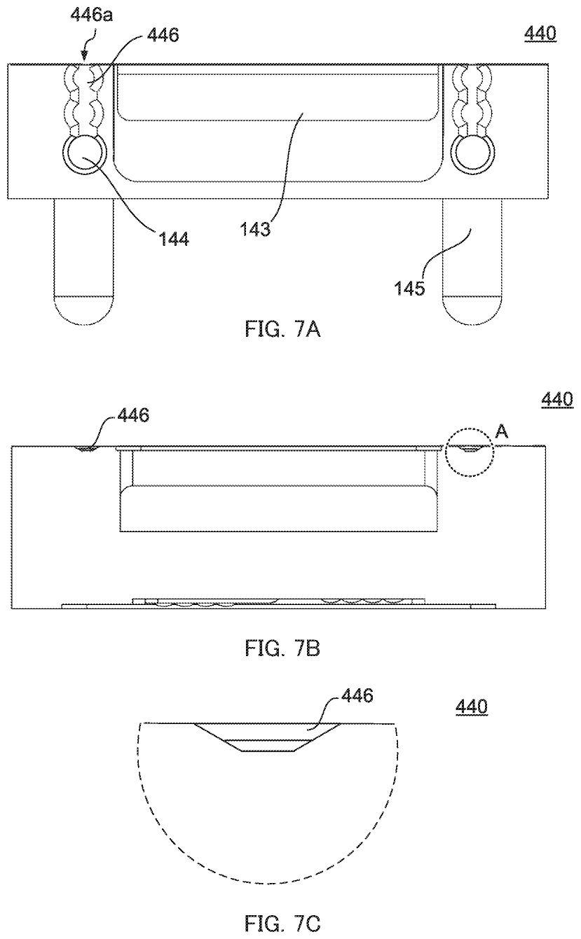

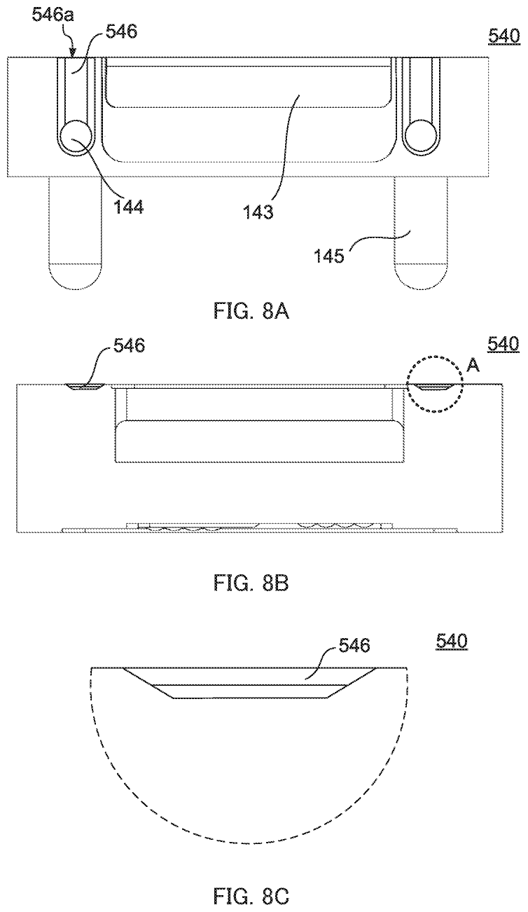

Here, FIGS. 5A to 5C, 6A to 6C, 7A to 7C, and 8A to 8C illustrate modifications of the optical-receptacle main body. FIGS. 5A, 6A, 7A, and 8A are respective plan views of optical-receptacle main bodies 240, 340, 440, and 540, FIGS. 5B, 6B, 7B, and 8B are respective rear views of optical-receptacle main bodies 240, 340, 440, and 540, FIGS. 5C, 6C, 7C, and 8C are respective partly-enlarged views of regions A circled with the dashed lines illustrated in FIGS. 5B, 6B, 7B, and 8B. Components the same between the aforementioned embodiment and the modifications are provided with the same reference signs in FIGS. 5A to 5C, 6A to 6C, 7A to 7C, and 8A to 8C. The shape of each of grooves 546 disposed in optical-receptacle main body 540 as seen in plan view may be linear as illustrated in FIGS. 8A to 8C, or, each of the grooves may have a zigzag shape, a shape of a chain of multiple circles, or other shapes like the shapes of each of grooves 246, 346, and 446 disposed in optical-receptacle main bodies 240, 340, and 440 as seen in plan view as illustrated in FIGS. 5A to 5C, 6A to 6C, and 7A to 7C. Pairs of grooves 246, 346, 446, or 546 do not have openings in the front surfaces of optical-receptacle main bodies 240, 340, 440, and 540 (in the surfaces on the side of second optical surfaces 142), respectively, but have openings 246a, 346a, 446a, and 546a only in the side of the rear surfaces of optical-receptacle main bodies 240, 340, 440, and 540, respectively. Note that, each pair of grooves 246, 346, 446, or 546 is disposed to extend along the optical axis of the reception light that is incident on second optical surfaces 142 and travels toward the side of reflective surface 143 and along the optical axis of the transmission light that is reflected on reflective surface 143 and travels toward second optical surfaces 142 (that is, along the direction in which the front surface and rear surface of optical-receptacle main body 240, 340, 440, or 540 are connected). Note also that, the sectional shape of each of grooves 246, 446, or 546 can also be trapezoidal as illustrated in FIGS. 5C, 7C, and 8C.

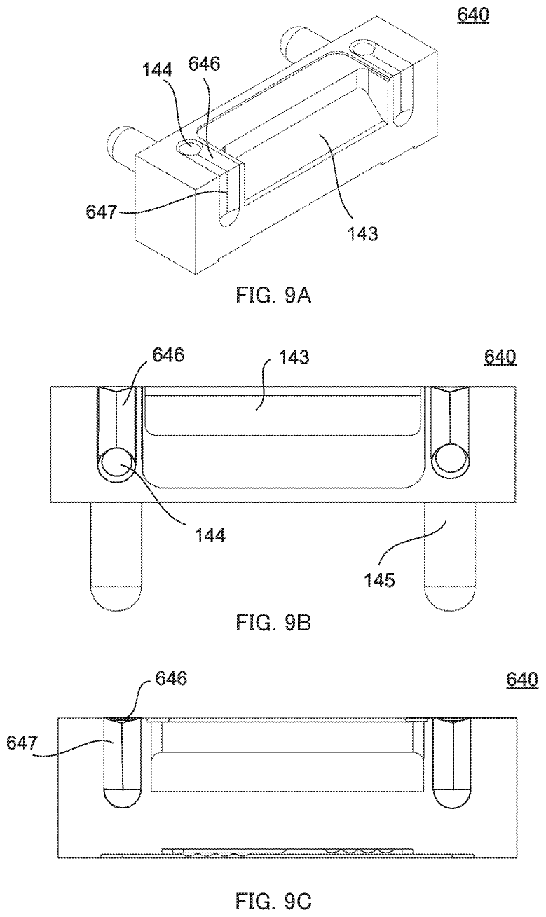

FIGS. 9A to 9C illustrate a further modification of the optical-receptacle main body. FIG. 9A is a perspective view of optical-receptacle main body 640, FIG. 9B is a plan view of optical-receptacle main body 640, and FIG. 9C is a rear view of optical-receptacle main body 640. Components the same between the aforementioned embodiment and the present modification are provided with the same reference signs in FIGS. 9A to 9C. Optical-receptacle main body 640 may include adhesive agent pockets 647 connected with grooves 646 as illustrated in FIGS. 9A to 9C. The shape of each of adhesive agent pockets 647 is not limited specifically as long as excessive part of the adhesive agent applied to grooves 646 can collect in adhesive agent pockets 647 and as long as adhesive agent pockets 647 do not affect the optical characteristics of optical-receptacle main body 640. For example, adhesive agent pockets 647 can be recesses formed in the rear surface of optical-receptacle main body 640 as illustrated in FIG. 9B. Optical-receptacle main body 640 includes adhesive agent pockets 647, so that it becomes possible to prevent the excessive part of the adhesive agent applied to grooves 646 from entering on the side of the first optical surfaces and from entering the reflective surface. Note that, adhesive agent pockets 647 may also be recesses or the like disposed in the top panel of the optical-receptacle main body. In this case, since the excessive part of the adhesive agent collects in the adhesive agent pockets, the grooves do not need to have openings in the side of the rear surface of the optical-receptacle main body.

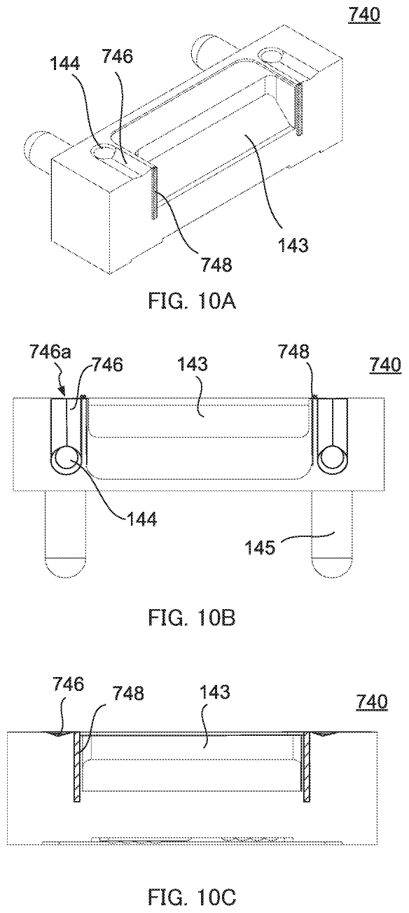

FIGS. 10A to 10C illustrate a further modification of the optical-receptacle main body. FIG. 10A is a perspective view of optical-receptacle main body 740, FIG. 10B is a plan view of optical-receptacle main body 740, and FIG. 10C is a rear view of optical-receptacle main body 740. Components the same between the aforementioned embodiment and the present modification are provided with the same reference signs in FIGS. 10A to 10C. Optical-receptacle main body 740 may include, at its rear surface, protrusions 748 disposed to prevent an adhesive agent from flowing onto reflective surface 143 during application of the adhesive agent as illustrated in FIGS. 10A to 10C. The shape of each of protrusions 748 is not limited specifically. For example, as illustrated in FIGS. 10A to 10C, protrusions 748 may also be linear protrusions disposed more closely to reflective surface 143 than openings 746a of grooves 746 are. Protrusions 748 may also be curved protrusions disposed more closely to reflective surface 143 than openings 746a of grooves 746 are. Protrusions 748 may also be U-shaped protrusions or the like disposed to surround openings 746a of grooves 746.

(Method for Producing Optical Module)

The aforementioned optical module can be produced by fixing the aforementioned optical receptacle to the substrate on which the light-emitting elements and the light-receiving elements are mounted.

Here, the photoelectric conversion device and the optical receptacle are aligned to each other based on the alignment mark formed on the substrate, the alignment mark formed on the supporting member, and/or the like. After aligning the photoelectric conversion device and the optical receptacle to each other, the substrate and the optical receptacle (supporting member) are fixed to each other with an adhesive agent, for example.

### Effect

In the optical receptacle according to the present invention, the optical-receptacle main body is not in contact with the substrate when disposed on the substrate, so that a space is formed between the substrate and the optical-receptacle main body as described above. Therefore, with the optical receptacle according to the embodiment of the present invention, it is possible to achieve a higher design flexibility for the wire-bonding position of the photoelectric conversion element, disposition of other optical components and electronic components, and/or the like. Moreover, the flexibility for the disposition position of the optical receptacle on the substrate also increases.

In addition, the optical-receptacle main body and the supporting member are adhered firmly to each other by the adhesive agent in the optical receptacle according to the embodiment of the present invention. Furthermore, the adhesive agent is disposed to extend in the direction along the optical axis of the light incident on the second optical surfaces or of the light emitted from the second optical surfaces (that is, along the direction in which a force is applied during attachment or detachment of the ferrule). Accordingly, the optical-receptacle main body is less likely to come off the supporting-member main body even when a load is applied to the front surface of the optical-receptacle main body during attachment or detachment of the ferrule to or from the optical-receptacle main body. That is, the optical receptacle having a greater strength can be achieved.

In addition, even when the adhesive agent is applied excessively in the grooves during attachment of the optical-receptacle main body and the supporting member to each other, the excessive part of the adhesive agent is discharged from the openings on the side of the rear surface of the optical-receptacle main body in the case where the ends of the grooves on the side of the rear surface of the optical-receptacle main body are open in the side of the rear surface of the optical-receptacle main body, or the excessive part of the adhesive agent is discharged into the adhesive agent pockets in the case where the ends of the grooves on the side of the rear surface of the optical-receptacle main body are connected with the adhesive agent pockets as described above. Accordingly, the optical-receptacle main body and the supporting-member main body can be joined tightly to each other, and can be adhered firmly to each other. Note that, in the case where the excessive part of the adhesive agent is discharged from the openings and the adhesive agent is disposed to project from the grooves on the side of the rear plate of the supporting-member main body, the projected part can also increase the adhesive strength between the optical-receptacle main body and the supporting member.

The present patent application claims the benefit of priority based on Japanese Patent Application No. 2016-236650 filed on Dec. 6, 2016. The disclosure of the specification, drawings and abstract of the Japanese Patent Application is incorporated in the specification of the present application by reference in its entirety.

### INDUSTRIAL APPLICABILITY

The optical receptacle and optical module according to the present invention are useful for optical communications using an optical transmission member, for example.

### REFERENCE SIGNS LIST

100 Optical module
110 Photoelectric conversion device
111 Light-emitting element
112 Light-receiving element
113 Substrate
120 Optical receptacle
130 Optical transmission member
132 Ferrule
140, 240, 340, 440, 540, 640, 740 Optical-receptacle main body
141 First optical surface
142 Second optical surface
143 Reflective surface
144 First fitting portion
145 Ferrule protrusion
146, 246, 346, 446, 546, 646, 746 Groove
150 Supporting member
151 Supporting-member main body
152 Second fitting portion
161 Top plate
162 Side plate
163 Front plate
164 Rear plate
170 Adhesive agent
647 Adhesive agent pocket
748 Protrusion

1. An optical receptacle to be disposed between a photoelectric conversion device and an optical transmission member, the photoelectric conversion device including a substrate and a photoelectric conversion element disposed on the substrate, the optical receptacle being configured to optically couple together the photoelectric conversion element and an end surface of the optical transmission member, the optical receptacle comprising:
an optical-receptacle main body; and
a supporting member that supports the optical-receptacle main body; and
an adhesive agent that adheres the optical-receptacle main body and the supporting member to each other,
wherein the optical-receptacle main body includes:
a first optical surface that allows incidence of transmission light emitted by the photoelectric conversion element, or emits, toward the photoelectric conversion element, reception light that has been emitted from the end surface of the optical transmission member and has passed through an inside of the optical-receptacle main body,
a second optical surface that emits, toward the optical transmission member, the transmission light that has been emitted by the photoelectric conversion element and has passed through the inside of the optical-receptacle main body, or allows incidence of the reception light emitted from the optical transmission member,
a reflective surface that reflects, toward the second optical surface, the transmission light incident on the first optical surface, or reflects, toward the first optical surface, the reception light incident on the second optical surface,
a first fitting portion disposed in or on a surface of the optical-receptacle main body located opposite the first optical surface, and
a groove disposed in the surface of the optical-receptacle main body located opposite the first optical surface, the groove being disposed to extend in a direction along an optical axis of the reception light that is incident on the second optical surface and travels toward the reflective surface or along an optical axis of the transmission light that is reflected on the reflective surface and travels toward the second optical surface, wherein the groove does not include an opening in a surface of the optical-receptacle main body on which the second optical surface is disposed,
wherein the supporting member includes:
a supporting-member main body including an installation surface for the supporting member to be installed on the substrate, and
a second fitting portion disposed on or in an inner side of the supporting-member main body at a position corresponding to the first fitting portion, the second fitting portion being fitted in or to the first fitting portion,
wherein the optical-receptacle main body is disposed on a side of the supporting member with respect to the installation surface, and
wherein the adhesive agent is disposed to be in contact with an inner wall surface of the groove of the optical-receptacle main body and with the inner side of the supporting-member main body.

2. The optical receptacle according to claim 1, wherein
the groove includes an opening in a surface of the optical-receptacle main body located opposite the second optical surface.

3. The optical receptacle according to claim 1, further comprising:
an adhesive agent pocket connected with the groove.

4. The optical receptacle according to claim 2, further comprising:
a protrusion disposed on the surface of the optical-receptacle main body located opposite the second optical surface, the protrusion being disposed to prevent the adhesive agent from flowing to the reflective surface.

5. The optical receptacle according to any one of claim 1, wherein
a sectional shape of the groove is V-shaped or trapezoidal.

6. An optical module, comprising:
a photoelectric conversion device including a substrate and a photoelectric conversion element disposed on the substrate; and
the optical receptacle according to any one of claim 1, wherein
the substrate and the optical-receptacle main body are spaced apart from each other.

7. A method for producing the optical receptacle according to any one of claim 1, the method comprising:
applying an adhesive agent to the groove of the optical-receptacle main body;
fitting the first fitting portion of the optical-receptacle main body to which the adhesive agent is applied, and the second fitting portion of the supporting member to each other; and
curing the adhesive agent.
